(19) United States
(12) Patent Application Publication
(10) Pub. No.: US 2021/0194764 A1
(43) Pub. Date: Jun. 24, 2021

(54) DISCOVERY OF VIRTUALIZED COMPUTING RESOURCES

(71) Applicant: ServiceNow, Inc., Santa Clara, CA (US)

(72) Inventors: Daniel Badyan, Tel Aviv (IL); Bary Solomon, Petah Tikva (IL); Hail Tal, Kohav Yair (IL); Asaf Garty, Sdei Hemed (IL); Shiri Hameiri, Kfar Saba (IL); Alexandra Feiguine, Sha'ar Efrayim (IL); Shay Herzog, Raanana (IL)

(21) Appl. No.: 16/721,526

(22) Filed: Dec. 19, 2019

(51) Int. Cl. H04L 12/24; G06F 9/455; G06F 9/50; G06F 16/22; H04L 29/08

(52) U.S. Cl. CPC H04L 41/0806; G06F 9/455; H04L 67/2804; G06F 16/22; G06F 9/5077

(57) ABSTRACT

An embodiment includes a computational instance of a remote network management platform that is associated with a managed network, wherein a database is disposed within the computational instance. One or more processors are configured to execute discovery of a supervisor device disposed in the managed network, which involves: (i) executing a first general discovery pattern, (ii) executing a supervisor device discovery pattern, and (iii) identifying a first set of configuration and operational parameters of the supervisor device, one or more physical devices managed by the supervisor device, and virtual devices hosted by each of the one or more physical devices. The one or more processors may also be configured to execute discovery of a particular virtual device of the virtual devices, which involves: (i) executing a second general discovery pattern, and (ii) identifying a second set of configuration and operational parameters of the particular virtual device.

### BACKGROUND

Virtualization of computing resources, such as processors, memory, and network capacity, has become common. Enterprises deploy virtualized servers and databases on their managed networks, and may use virtualized resources that are made available by public cloud-based services. Conventional discovery procedures that seek to determine the computing hardware, software, and configurations thereof accessible to the enterprise (e.g., disposed within a managed network or a public cloud-based service) are often unable to determine the extent of these virtualized computing resources.

### SUMMARY

The embodiments herein provide a number of specific mechanisms and procedures through which virtualized computing resources can be discovered. In particular, the virtualized resources are represented as a hierarchy with a physical resource (e.g., a device or database) hosting one or more virtual resources (e.g., virtual devices or virtual databases). Based on this arrangement, the physical and virtual resources may be discovered independently, and then relationships between them determined by attributes associated with the resources. Alternatively or additionally, the resources can be discovered according to the hierarchy, with the physical resources discovered first and their respective virtual resources discovered afterward.

Accordingly, a first example embodiment may include a computational instance of a remote network management platform that is associated with a managed network, wherein a database is disposed within the computational instance. The first example embodiment may further include one or more processors configured to execute discovery of a supervisor device disposed in the managed network, wherein the discovery of the supervisor device involves: (i) executing a first general discovery pattern, (ii) based on output of commands invoked on the supervisor device by the first general discovery pattern, executing a supervisor device discovery pattern on the supervisor device, (iii) based on results of the executing the supervisor device discovery pattern, identifying a first set of configuration and operational parameters of the supervisor device, one or more physical devices managed by the supervisor device, and virtual devices hosted by each of the one or more physical devices, and (iv) storing, in the database, the first set of configuration and operational parameters. The one or more processors may also be configured to execute discovery of a particular virtual device of the virtual devices, wherein executing discovery of the particular virtual device involves: (i) executing a second general discovery pattern, (ii) based on output of commands invoked on the particular virtual device by the second general discovery pattern, identifying a second set of configuration and operational parameters of the particular virtual device, and (iii) storing, in the database, the second set of configuration and operational parameters, wherein a unique identifier of the particular virtual device is used to relate information from the first set and the second set in the database.

A second example embodiment may include executing, by one or more processors, discovery of a supervisor device disposed in a managed network, wherein the discovery of the supervisor device involves: (i) executing a first general discovery pattern, (ii) based on output of commands invoked on the supervisor device by the first general discovery pattern, executing a supervisor device discovery pattern on the supervisor device, (iii) based on results of the executing the supervisor device discovery pattern, identifying a first set of configuration and operational parameters of the supervisor device, one or more physical devices managed by the supervisor device, and virtual devices hosted by each of the one or more physical devices, and (iv) storing, in a database, the first set of configuration and operational parameters. The second example embodiment may also include executing, by the one or more processors, discovery of a particular virtual device of the virtual devices, wherein executing discovery of the particular virtual device involves: (i) executing a second general discovery pattern, (ii) based on output of commands invoked on the particular virtual device by the second general discovery pattern, identifying a second set of configuration and operational parameters of the particular virtual device, and (iii) storing, in the database, the second set of configuration and operational parameters, wherein a unique identifier of the particular virtual device is used to relate information from the first set and the second set in the database.

A third example embodiment may involve a computational instance of a remote network management platform that is associated with a managed network, wherein a configuration management database is disposed within the computational instance. The third example embodiment may further involve one or more processors configured to: (i) query a configuration table of a physical database on the managed network; (ii) determine, from configuration information provided in response to the query of the configuration table, that the physical database is virtualized; (iii) query a virtualization table of the physical database; (iv) determine, from virtualization information provided in response to the query of the virtualization table, names, sizes, and storage utilizations of one or more virtual databases that are hosted by the physical database; and (v) store, in the configuration management database, representations of the physical database, the configuration information, the virtual databases, and the virtualization information.

A fourth example embodiment may involve querying, by one or more processors, a configuration table of a physical database on a managed network, wherein a computational instance of a remote network management platform is associated with the managed network. The fourth example embodiment may further involve determining, by the one or more processors and from configuration information provided in response to the query of the configuration table, that the physical database is virtualized. The fourth example embodiment may further involve querying, by the one or more processors, a virtualization table of the physical database. The fourth example embodiment may further involve determining, by the one or more processors and from virtualization information provided in response to the query of the virtualization table, names, sizes, and storage utilizations of one or more virtual databases that are hosted by the physical database. The fourth example embodiment may further involve storing, by the one or more processors and in a configuration management database, representations of the physical database, the configuration information, the virtual databases, and the virtualization information, wherein the configuration management database is disposed in the computational instance.

In a fifth example embodiment, an article of manufacture may include a non-transitory computer-readable medium, having stored thereon program instructions that, upon execution by a computing system, cause the computing system to perform operations in accordance with the first, second, third, and/or fourth example embodiment.

In a sixth example embodiment, a computing system may include at least one processor, as well as memory and program instructions. The program instructions may be stored in the memory, and upon execution by the at least one processor, cause the computing system to perform operations in accordance with the first, second, third, and/or fourth example embodiment.

In a seventh example embodiment, a system may include various means for carrying out each of the operations of the first, second, third, and/or fourth example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 depicts virtualized computing resources, in accordance with example embodiments.

FIG. 7A is a message flow diagram of a discovery process, in accordance with example embodiments.

FIG. 7B is another message flow diagram of a discovery process, in accordance with example embodiments.

FIG. 7C depicts a database schema, in accordance with example embodiments.

FIG. 8 is a flow chart, in accordance with example embodiments.

FIG. 9 depicts a virtualized database, in accordance with example embodiments.

FIG. 10 is a message flow diagram of a discovery process, in accordance with example embodiments.

FIG. 11 depicts a database schema, in accordance with example embodiments.

FIG. 12 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

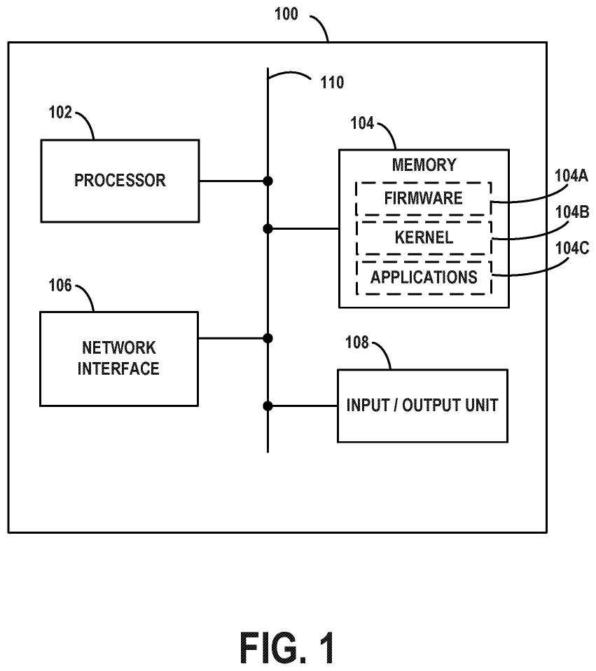

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

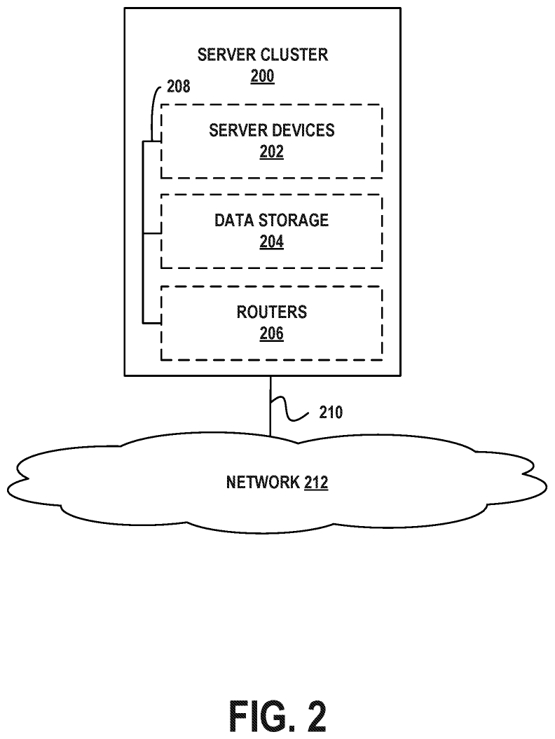

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

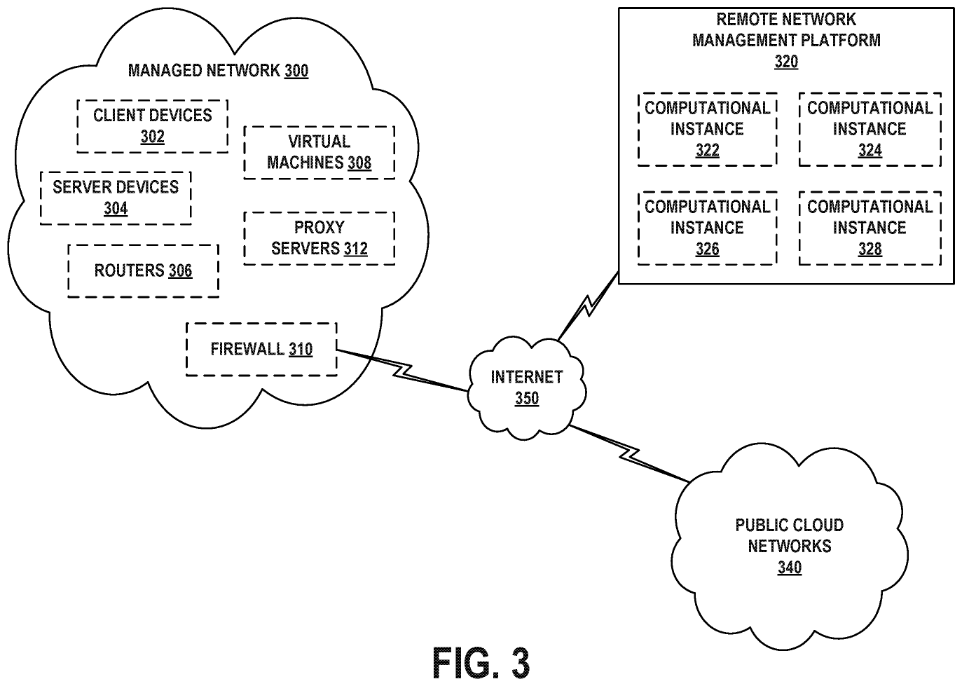

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

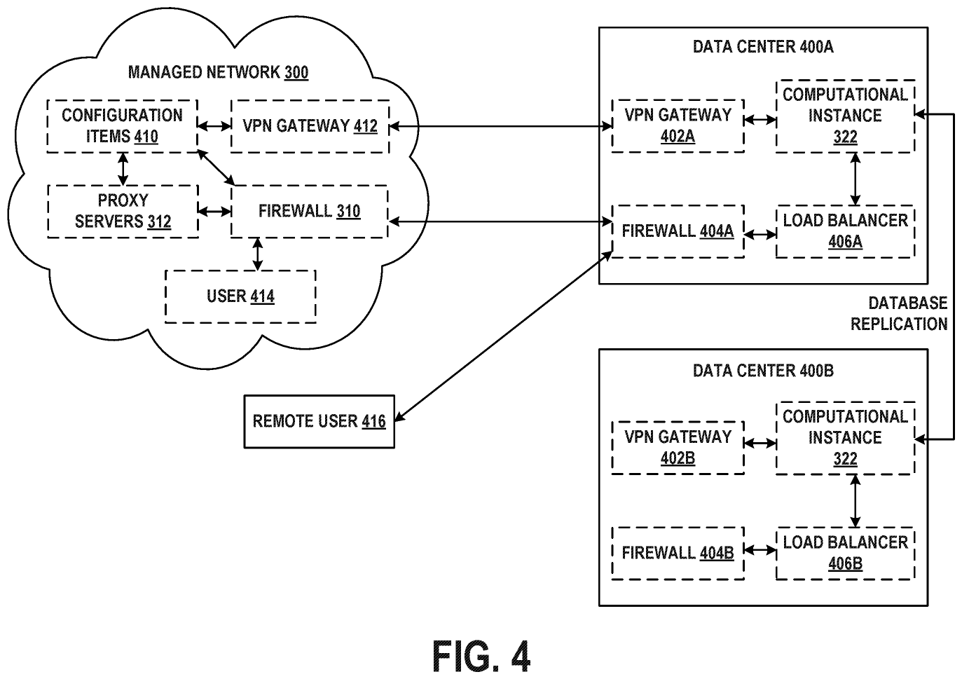

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

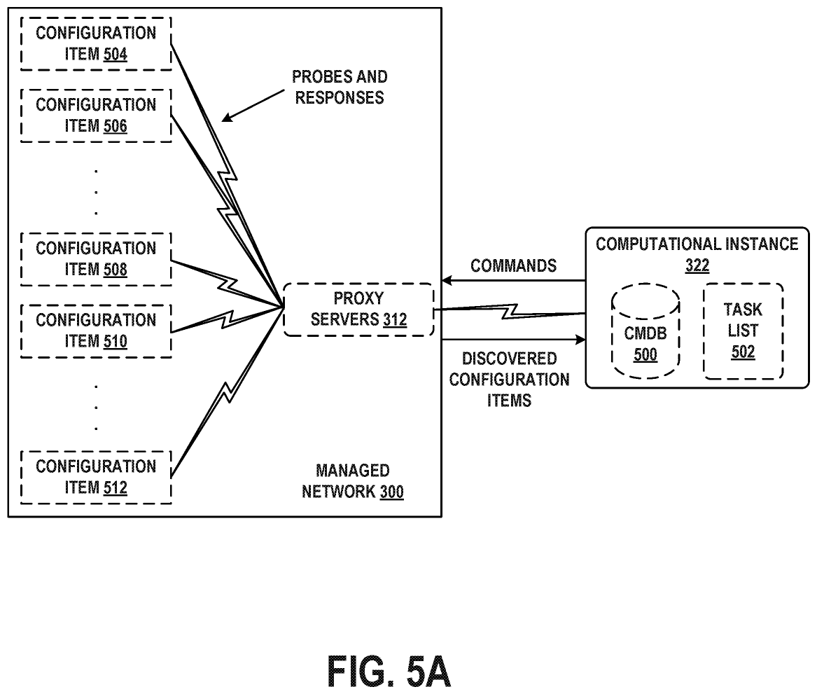

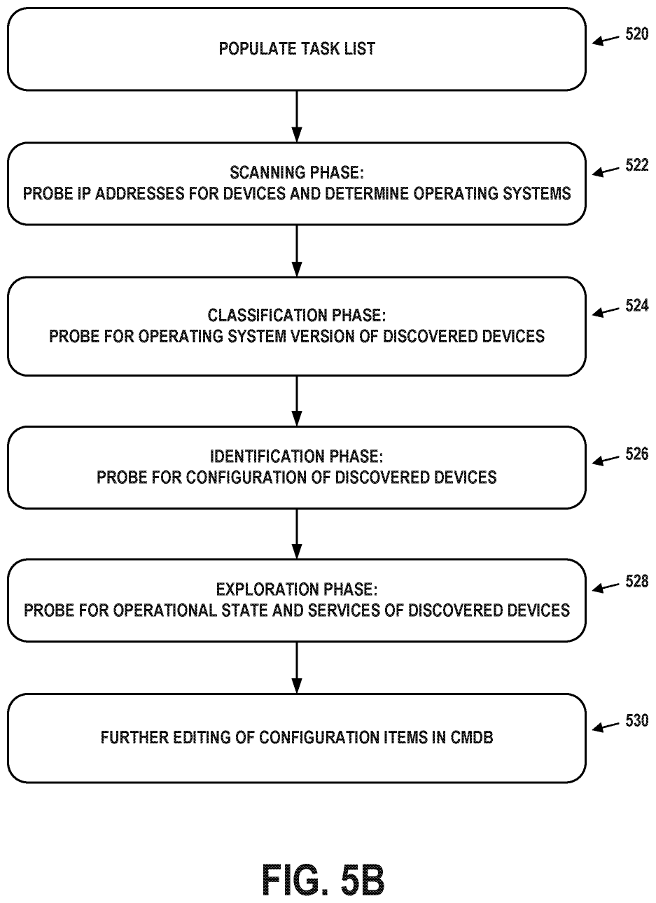

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. Virtualized Computing

As noted previously, virtualized computing resources involve a physical computing device that contains and operates one or more virtual devices. Each virtual device may obtain a fraction or share of its physical device's computational, storage, and/or communication resources. This share may be dedicated or provided on demand.

Virtualization provides many advantages to enterprises and other organizations, including the ability to make more efficient use of computing resources as well as to isolate certain operations and data from other operations and data. Often, dozens or hundreds of virtual devices can reside on a single computing device or computing cluster.

Thus, enterprises may make use of virtualized computing devices on their enterprise networks (e.g., managed network 300). And it is desirable for a remote network management platform (e.g., by way of computational instance 322 and proxy servers) to be able to discover these devices, and store representations thereof in a database (e.g., CMDB 500).

Accordingly, discovery patterns may be developed to probe, identify, and catalog the virtualized resources on a managed network. These discovery patterns may encompass program logic that remotely accesses the virtualized resources. The discovery patterns may also remotely access related devices and modules such as management console and supervisor platforms, to do so. While some aspects of discovery patterns may be customized to discover resources provided by a particular vendor, other aspects are generalized for multiple providers of virtualized computing devices. Further, these discovery patterns may also be used or adapted to discover virtual resources in public cloud networks (e.g., public cloud networks 340).

The sections below divide discovery patterns into two types—those that discover virtual device architectures, and those that discover virtual database architectures. Nonetheless, this division is made merely for purposes of convenience. Notably, virtual device architectures often include some extent of virtual storage (such as a virtual database) that is discovered along with the virtual devices. Further, discovery patterns combining virtual device and virtual database discovery may be employed. Thus, the separate descriptions of two types of patterns below should not be taken to indicate that the embodiments thereof cannot be combined in various ways.

### VI. Discovery of Virtual Device Architectures

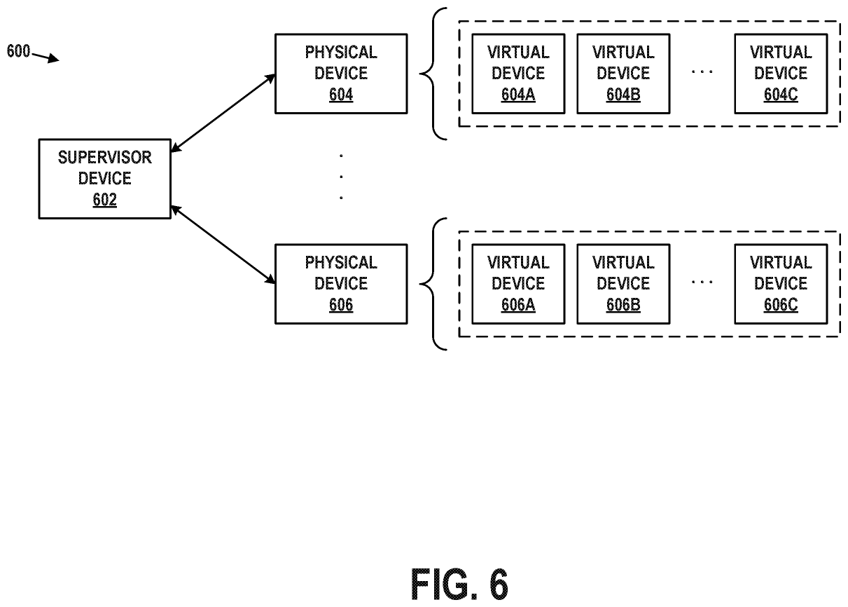

FIG. 6 depicts arrangement 600 of virtualized computing resources. Supervisor device 602 may be a management console that provides planning, deployment, and managing of one or more physical devices, including physical device 604 and physical device 606. By way of a command line, web interface, representational state transfer (REST) interface, and/or simple object access protocol (SOAP) interface supported by supervisor device 602, a user may be able to add physical devices to be managed by supervisor device 602 and remove physical devices from being managed by supervisor device 602. Further, the user may be able to modify the configuration of physical devices being managed by supervisor device 602, as well as generate or obtain reports on the configuration and performance of these physical devices. For example, such a report may indicate the number of physical devices being managed by supervisor device 602, as well as identifiers, names, locations, network addresses, and/or resource utilizations of each.

Each physical device may host one or more virtual devices. For example, physical device 604 hosts virtual devices 604A, 604B, and 604C, while physical device 606 hosts virtual devices 606A, 606B, and 606C. From supervisor device 602, the user may also be able to add, remove, or modify the configuration of virtual devices hosted by a physical device. Also, the user may be able to generate or obtain reports on the configuration and performance of these virtual devices. For example, such a report may indicate the number of virtual devices per physical device, as well as identifiers, names, network addresses, and/or operating system (e.g., AIX®, LINUX®, WINDOWS®) of each. Further, the report may also indicate the number of processors, processor cores, memory, and/or other resources dedicated to each.

While the embodiment of FIG. 6 depicts two physical devices each hosting three virtual devices, a supervisor device may be able to manage more or fewer physical devices. Further, each physical device may be able to manage more or fewer virtual devices. Thus, this embodiment is for purposes of illustration and is not intended to be limiting.

Some embodiments in accordance with arrangement 600 may incorporate an IBM® hardware management console (HMC) as supervisor device 602. These embodiments may also refer to physical devices as frames and virtual devices as logical partitions (LPARs). Further, one or more LPARs may referred to as virtual input/output (VIO) servers, and may be dedicated to managing physical interface and peripheral components (e.g., network interface modules and ports, optical drives, etc.) on behalf of other LPARs.

In some embodiments, LPARs of one or more physical devices may be logically grouped into pools. This allows common policies to be applied across multiple LPARs without having to explicitly configure each LPAR with the policies.

In the discussion below, certain terminology and commands may be specific to the IBM® HMC products, but the discovery pattern is generic enough to work with other products and products from other vendors.

A. Supervisor Device and Physical Device Discovery

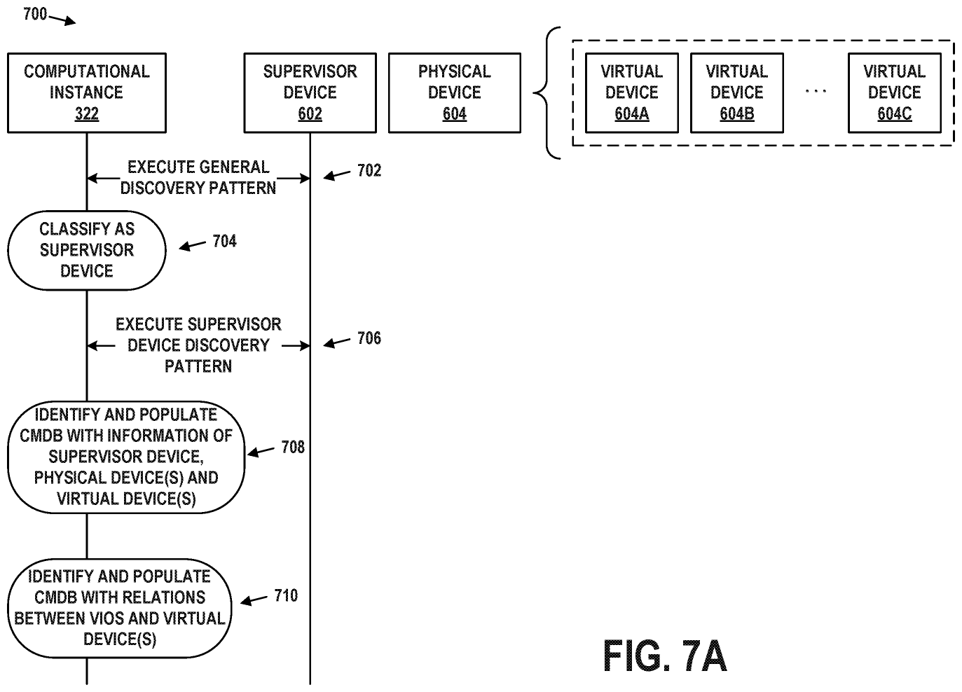

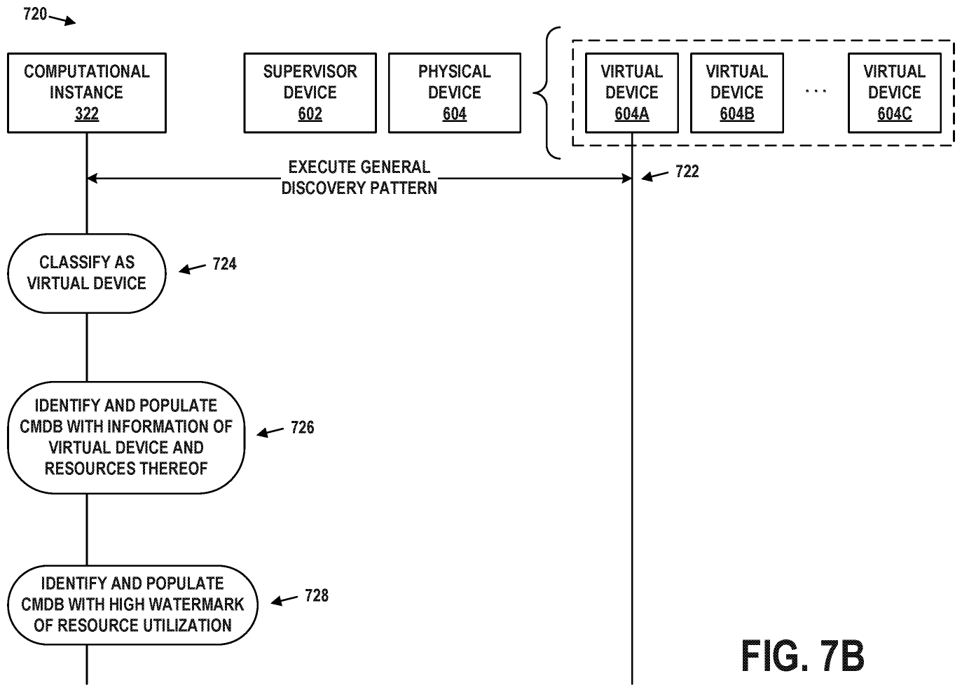

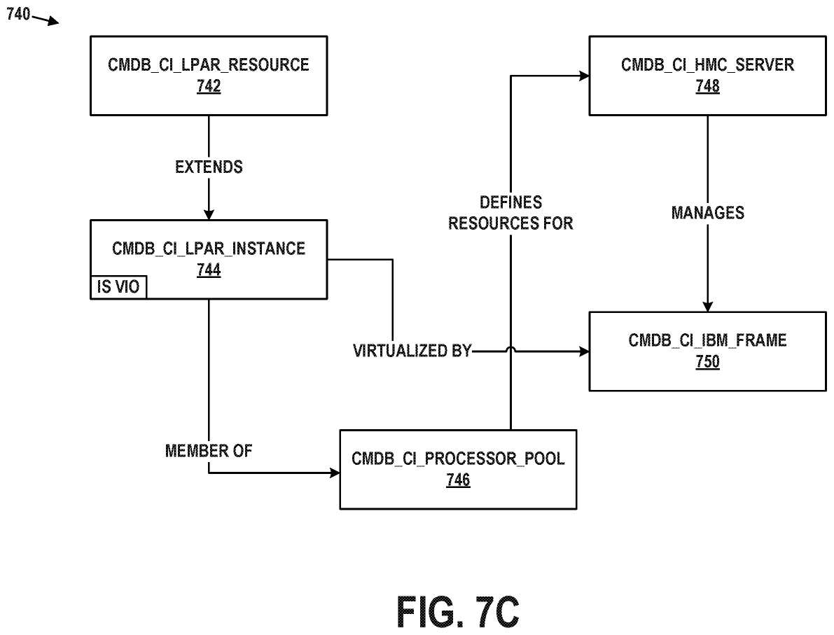

FIG. 7A depicts discovery of a supervisor device (HMC) and the physical devices (frames) that it manages. As described above, discovery may be carried out by a computational instance providing instructions to a proxy server on the managed network, and the proxy server executing probes of the supervisor device.

In some embodiments, these probes may involve the proxy server remotely logging on to the supervisor device (e.g., via SSH), running one or more commands by way of a command shell, and gathering the output of these commands. From this output the computational instance and/or the proxy server can identify configuration items and associated attributes, and save these to a CMDB. Other possibilities include probing various devices on the managed network by way of other protocols, such as SNMP or a REST or SOAP interface.

Regardless, message flow diagram 700 of FIG. 7A depicts computational instance 322 carrying out a series of steps. While a proxy server may be involved in these steps, it is omitted from message flow diagram 700 for sake of simplicity.

At step 702, computational instance 322 executes a general discovery pattern on supervisor device 602. This may involve computational instance 322 identifying that supervisor device 602 is running a variation of the UNIX® operating system (e.g., LINUX®) and then remotely logging on to supervisor device 602 and executing commands. The output of one or more of these commands may indicate that supervisor device 602 manages an arrangement of physical devices and virtual devices. For example, the shell command “lshmc” only exists on HMC devices. Thus, execution of “lshmc -V”, if successful, provides the version of the HMC device, which can be stored in a file. Otherwise, the output may indicate that the “lshmc” command is unknown, which means that the device is not an HMC.

At step 704, based on the content of the file, supervisor device 602 is classified as such (e.g., as an HMC). This classification triggers the eventual execution of a discovery pattern specific to supervisor devices.

Accordingly, in step 706, computational instance 322 executes this supervisory device discovery pattern. This discovery pattern may involve executing the shell commands “lshmc”, “lssyscfg”, and/or “lshwres” with various parameters. For example, “lshmc” can provide HMC configuration information for supervisor device 602, such as the BIOS level, locale information, network settings, remote access settings, firewall settings, network routing information, and syslog server configuration, among other items. The “lssyscfg” shell command can list physical devices (frames) and virtual devices (LPARs) managed by supervisor device 602, as well as attributes thereof. The “lshwres” shell command can list the hardware resources of the physical device(s), including physical I/O ports, virtual I/O ports, memory, any shared memory pool, processors, any shared processor pool, among other possibilities.

TABLE 1
cmdb_ci_hmc_server

| | |
|---|---|
| name | Name of this HMC |
| frame_count | Number of frames managed by this HMC |
| serial_number | Unique identifier of this HMC |
| IP_address | IP address of this HMC |
| OS_version | Version of the operating system used by this HMC |
| CPU_type | Type of CPU(s) used by this HMC |
| CPU_speed | Speed of CPU(s) used by this HMC |
| CPU_core_count | Number of cores per CPU used by this HMC |
| RAM | Amount of main memory available to this HMC |

By executing a combination of these commands, perhaps with various parameters, the information in Table 1 can be obtained. This information may be stored in a table in the CMDB (e.g., named cmdb_ci_hmc_server) at step 708.

Further, computational instance 322 may execute the shell command “lssyscfg -r sys” or “lssyscfg -r frame” to obtain a list of physical devices (frames) managed by the supervisor device 602 (HMC). The list may include names and/or serial numbers of the managed frames or other unique identifiers. Then, computational instance 322 may iterate through the discovered frames by executing the shell command “lssyscfg -r sys -e <frame_name>” or a variation thereof for each discovered frame. In these commands, the <frame_name> parameter is the unique identifier of each frame as previously discovered.

TABLE 2
cmdb_ci_ibm_frame

| | |
|---|---|
| name | Name of this frame |
| serial_number | Unique identifier of this frame |
| curr_avail_sys_proc_units | Current available processor units of this |
| | frame |
| configurable_sys_proc_units | Configurable processor units of this frame |
| installed_sys_proc_units | Installed processor units of this frame |
| curr_avail_sys_mem | Current available memory units of this |
| | frame |
| configurable_sys_mem | Configurable memory units of this frame |
| installed_sys_mem | Installed memory units of this frame |

By executing a combination of these commands, perhaps with various parameters, the information in Table 2 can be obtained. This information may be stored in a table in the CMDB (e.g., named cmdb_ci_ibm_frame) at step 708.

Additionally, computational instance 322 may execute the shell command “lssyscfg -r lpar” to obtain a list of virtual devices (LPAR) managed by the supervisor device 602 (HMC). Alternatively, this list can be obtained per frame by executing a series of shell commands in the form of “lssyscfg -r lpar -m <frame_name> for each frame. The list may include names and/or serial numbers of the managed LPARs or other unique identifiers.

By executing a combination of these commands, perhaps with various parameters, the information in Table 3 can be obtained. This information may be stored in a table in the CMDB (e.g., named cmdb_ci_lpar_instance) at step 708.

Step 710 may involve determining the LPARs configured as VIOs and the relationships between these VIOs and the LPARs they manage. This information may be derived from the is_vio and vio_servers entries in Table 3.

TABLE 3
cmdb_ci_lpar_instance

| | |
|---|---|
| name | Name of this LPAR |
| state | State of this LPAR (“Running” translated to “on” and |
| | “Not Activated” and “Not Available” translated to “off”) |
| serial_number | Serial number of this LPAR |
| object_ID | A unique identifier for this LPAR formed by |
| | concatenating the LPAR's serial number and the |
| | serial number of its frame |
| is_vio | Set when this LPAR is a VIO server, not set otherwise |
| vio_servers | For client LPARs, signifies the VIO servers that manage |
| | them and, for VIO servers, signifies the client LPARs |
| | they manage |

From the output of these commands, the hierarchy of the supervisor device, its managed physical devices, and their virtual devices can be established. For example, the object ID contains the serial number of each LPAR's respective frame and thus associates virtual devices to the physical device on which they operate. While this level of information provides a reasonable amount of detail regarding a virtualized computing environment, even more information can be obtained by performing further discovery on the LPARs.

The procedures of message flow diagram 700 may be repeated for each discovered physical device.

B. Virtual Device Discovery

FIG. 7B depicts discovery of a virtual device (e.g., an LPAR). As described above, discovery may be carried out by a computational instance providing instructions to a proxy server on the managed network, and the proxy server executing probes of the supervisor device. Message flow diagram 720 of FIG. 7B depicts computational instance 322 carrying out these steps. While a proxy server may be involved in the steps, it is omitted from message flow diagram 720 for sake of simplicity. Some or all of the steps depicted in FIG. 7B may be carried out for each virtual device.

At step 722, computational instance 322 executes a general discovery probe of virtual device 604A. At this point, computational instance 322 may have determined that there is a device using the IP address of virtual device 604A, but not whether this device is physical or virtual.

At step 724, computational instance 322 classifies virtual device 604A as a virtual device. Doing so may involve executing the shell command “lparstat -i” on virtual device 604A. If this command does not exist on the device or fails for other reasons, then the device is not classified as being virtual. If this command is successful, its output can be used to define the virtual device as an LPAR.

Notably, LPARs may be configured so that they belong to shared processor pools. This controls the amount of processor capacity that LPAR can use from the available physical processors of the physical device. Each shared processor pool is associated with a maximum processing unit value. This value defines the upper boundary of the processor capacity that can be used by the set of partitions in the shared processor pool.

The output of the “lparstat -i” may include information regarding the configuration of the LPAR. This may include, but is not limited to, the name, serial number, power mode, online virtual processors, maximum virtual processors, online memory, maximum memory, active physical processors, maximum physical processors, pool identifier, number of processors in the pool, processing capacity of the pool, and maximum processing capacity of the pool for the LPAR.

At step 726, some or all of this information may be stored in the cmdb_ci_lpar resource table of the CMDB. Further, information relating to shared processor pools may be stored in the cmdb_ci_processorpool table of the CMDB.

Notably, if virtual device 604A has already been discovered as an LPAR during HMC discovery as shown in FIG. 7A, reconciliation procedures of the CMDB will result in the existing configuration item to be enhanced with any new attributes discovered during the procedure of FIG. 7B. Conversely, if an LPAR is first discovered during the procedure of FIG. 7B, CMDB reconciliation procedures will result in the existing configuration item being enhanced with any new attributes discovered during the procedure of FIG. 7A. The name and/or serial number of the LPAR may be used as a unique identifier of the configuration item, and thus may be used to correlate different set of attributes discovered by both procedures into a common configuration item. Therefore, there is no need to create a second configuration item for the LPAR in these situations. This means that the procedures of FIGS. 7A and 7B can occur independently and/or in any order.

At step 728, computational instance 322 determines whether the high watermark of resource utilization has been exceeded for this LPAR. Notably, the results of the “lprstat -i” command provides the current usage of online virtual processors. If this usage exceeds the previously stored highest value thereof, this value is overwritten with the current usage. If the value of online virtual processors is lower than the high watermark, it remains the same. This provides a sense of the maximum processor utilization associated with the LPAR.

The procedures of message flow diagram 720 may be repeated for each discovered virtual device.

C. Schema

FIG. 7C defines partial schema 740 with which a CMDB can store information about and relationships between configuration items discovered with the procedures of FIGS. 7A and 7B. In particular, relationships between the CMDB tables discussed above are defined. Partial schema 740 could be part of a larger schema that relates these tables with other CMDB tables.

Table cmdb_ci_lpar resource 742 contains information relating to discovered LPARs, and extends table cmdb_ci_lpar_instance 744, which also contains information relating to discovered LPARs. Entries in table cmdb_ci_lpar_instance 744 are members of entries in table cmdb_ci_processor_pool 746 and are virtualized by entries in table cmdb_ci_ibm_frame 750. Entries in table cmdb_ci_processor_pool 746 contain information relating to processor pools for LPARs, and define resources for entries in table cmdb_ci_hmc_server 748. Entries in table cmdb_ci_ibm_frame 750 contain information relating to discovered frames. Entries in table cmdb_ci_hmc_server 748 contain information relating to HMCs, and these manage entries in table cmdb_ci_ibm_frame 750.

D. Example Operations

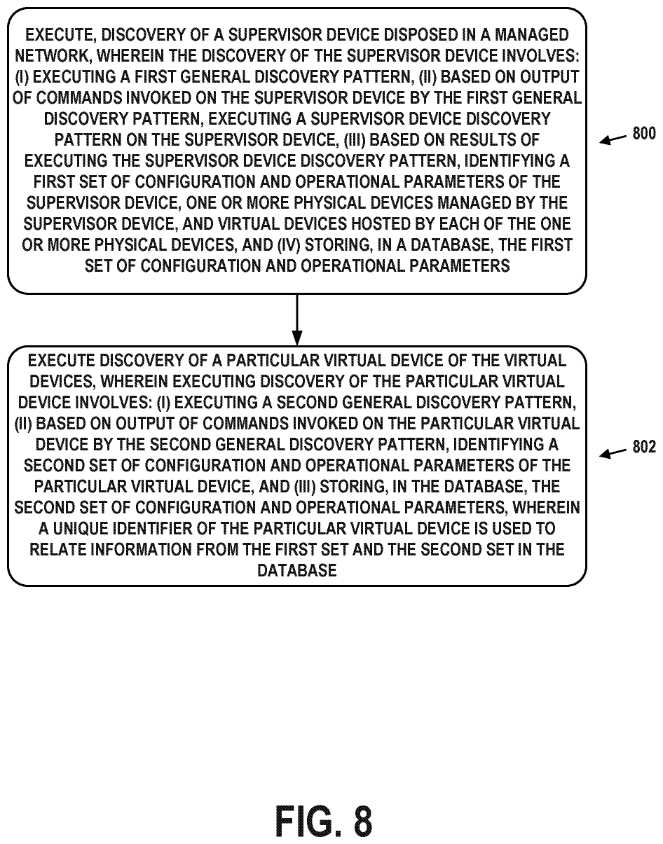

FIG. 8 is a flow chart illustrating an example embodiment. The process illustrated by FIG. 8 may be carried out by a computing device, such as computing device 100, and/or a cluster of computing devices, such as server cluster 200, computational instance 322, or a combination of computational instance 322 and proxy server 312. However, the process can be carried out by other types of devices or device subsystems.

The embodiments of FIG. 8 may be simplified by the removal of any one or more of the features shown therein. Further, these embodiments may be combined with features, aspects, and/or implementations of any of the previous figures or otherwise described herein.

Block 800 includes executing, by one or more processors, discovery of a supervisor device (e.g., an HMC) disposed in a managed network, wherein the discovery of the supervisor device involves: (i) executing a first general discovery pattern, (ii) based on output of commands invoked on the supervisor device by the first general discovery pattern, executing a supervisor device discovery pattern on the supervisor device, (iii) based on results of executing the supervisor device discovery pattern, identifying a first set of configuration and operational parameters of the supervisor device, one or more physical devices (e.g., frames) managed by the supervisor device, and virtual devices (LPARs) hosted by each of the one or more physical devices, and (iv) storing, in a database, the first set of configuration and operational parameters.

Block 802 involves executing, by the one or more processors, discovery of a particular virtual device of the virtual devices, wherein executing discovery of the particular virtual device involves: (i) executing a second general discovery pattern, (ii) based on output of commands invoked on the particular virtual device by the second general discovery pattern, identifying a second set of configuration and operational parameters of the particular virtual device, and (iii) storing, in the database, the second set of configuration and operational parameters, wherein a unique identifier of the particular virtual device is used to relate information from the first set and the second set in the database.

In some embodiments, a proxy server device is disposed within the managed network and controlled by a computational instance, wherein the one or more processors are disposed in the proxy server device and the computational instance. In other embodiments, the one or more processors are disposed in the computational instance.

In some embodiments, the discovery of the supervisor device occurs before the discovery of the particular virtual device. In other embodiments, discovery of the particular virtual device occurs before the discovery of the supervisor device.

In some embodiments, the commands invoked on the supervisor device and the commands invoked on the particular virtual device are shell commands invoked by remotely accessing the supervisor device and the particular virtual device, respectively.

In some embodiments, the first set of configuration and operational parameters include data indicating that the one or more physical devices are managed by the supervisor device and that each of the one or more physical devices hosts one or more of the virtual devices, wherein parts of the first set of configuration and operational parameters that relate to discovered supervisor devices, discovered physical devices, and discovered virtual devices are respectively stored in different tables of the database.

In some embodiments, some of the virtual devices are virtual input/output (VIO) servers that are dedicated to managing physical interface or peripheral components of their respective physical devices, wherein at least some non-VIO virtual devices use one of the VIO servers to access the physical interface or peripheral components.

In some embodiments, the database maintains a high watermark of resource utilization for the particular virtual device, wherein the second set of configuration and operational parameters contains an updated measurement of resource utilization for the particular virtual device, and wherein executing discovery of the particular virtual device involves, when the updated measurement exceeds the high watermark, replacing the high watermark with the updated measurement.

Some embodiments may further include executing discovery of a second particular virtual device of the virtual devices, wherein executing discovery of the second particular virtual device involves: (i) executing the second general discovery pattern, (ii) based on output of commands invoked on the second particular virtual device by the second general discovery pattern, identifying a third set of configuration and operational parameters of the second particular virtual device, and (iii) storing, in the database, the third set of configuration and operational parameters, wherein a second unique identifier of the second particular virtual device is used to relate information from the first set and the third set in the database.

### VII. Discovery of Virtual Database Architectures

Not unlike computing resources in general, databases can also be virtualized. A virtualized database architecture may involve a physical database device (also referred to as a container database) that can be configured to include one or more virtual databases (also referred to as pluggable databases). Virtual databases appear to devices external to their physical database (e.g., to client devices) similarly to non-virtual databases, and behave accordingly. Both physical and virtual databases may contain tables, and each virtual database may be restricted to being able to access only its own tables.

In this way, virtualized databases can be consolidated on a single server in a fashion that is easier to manage, more secure, and more flexible than having multiple independent databases operating on the same physical server or multiple independent database schemas in the same database. Particularly, computing resources (e.g., processor and/or memory capacity) can be assigned to virtual databases in a fashion that reflects their respective needs.

A virtualized database architecture may be discovered by executing SQL queries (or queries in other supported query languages) on the physical database and/or the virtual databases. Thus, a device remotely accessing the virtualized database architecture may be configured with a userid/password pair or other credentials usable to log on to the virtualized database architecture and access various tables that store the configuration thereof.

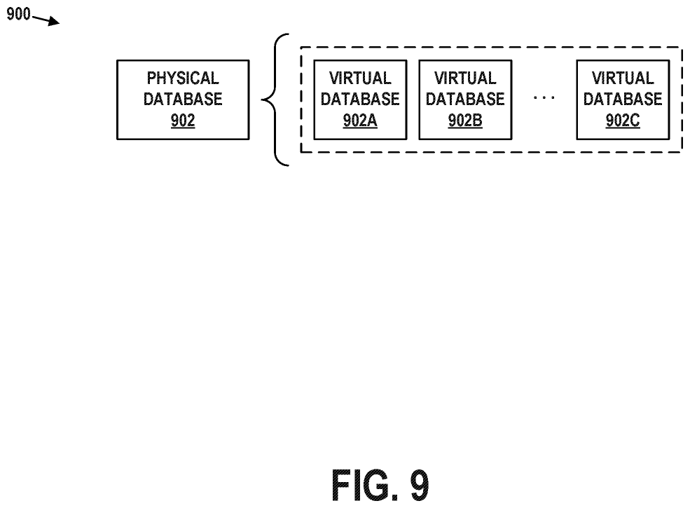

FIG. 9 depicts such virtualized database architecture 900. Physical database 902 includes virtual databases 902A, 902B, and 902C. However, a physical database may be configured to contain more or fewer virtual databases.

Physical database 902 may store various types of files that house the database configuration information, its schema, and the content of its tables. Often these files are stored in binary format, so the database may support special table constructs that can be used to more easily obtain human-readable information from the data files by way of queries. In the discussion below, table constructs used by ORACLE® databases are used as examples. Other table constructs may be possible.

Data files are typically the largest file types in a database, and store the actual data that was written to the database (e.g., the database schema and content of its tables) as well as administrative data. ORACLE® databases may support the V$DATAFILE table, which contains entries respectively related to the data files of the database. This may include the filenames, sizes, creation times, last update times, backup information, etc. of these data files.

Temporary (temp) files are similar to data files, but hold temporary information. For example, a temp file may be created and used when a table is sorted. After the sort operation completed, the temp file may be deleted. ORACLE® databases may support the V$TEMPFILE table, which contains entries respectively related to the temp files of the database.

Log files contain information related to the operations performed by the database. Depending on the logging configuration, each write to the database or read from the database (along with relevant timestamps thereof) may be logged in a log file. In some cases, log files may contain enough information that a database can be rolled back to a previous state. ORACLE® databases may support the V$LOG table, which contains entries respectively related to the log files of the database.

An additional table construct may display general configuration information about the database, such as name, date created, log mode, and whether the database is a container for virtual databases. ORACLE® databases may support the V$DATABASE table, which contains entries related to such configuration information. Yet another table construct may contain the size (in bytes or blocks) of each data file. ORACLE® databases may support the DBA FREE SPACE table, which contains entries related to such configuration information.

For virtualized databases, a further table construct may store information for each of the virtual databases hosted by the physical database. This information may include the virtual databases' names, modes, and size in bytes of the associated data files and temp files. ORACLE® databases may support the V$PDBS table, which contains entries related to such virtual databases.

A. Discovery Procedure

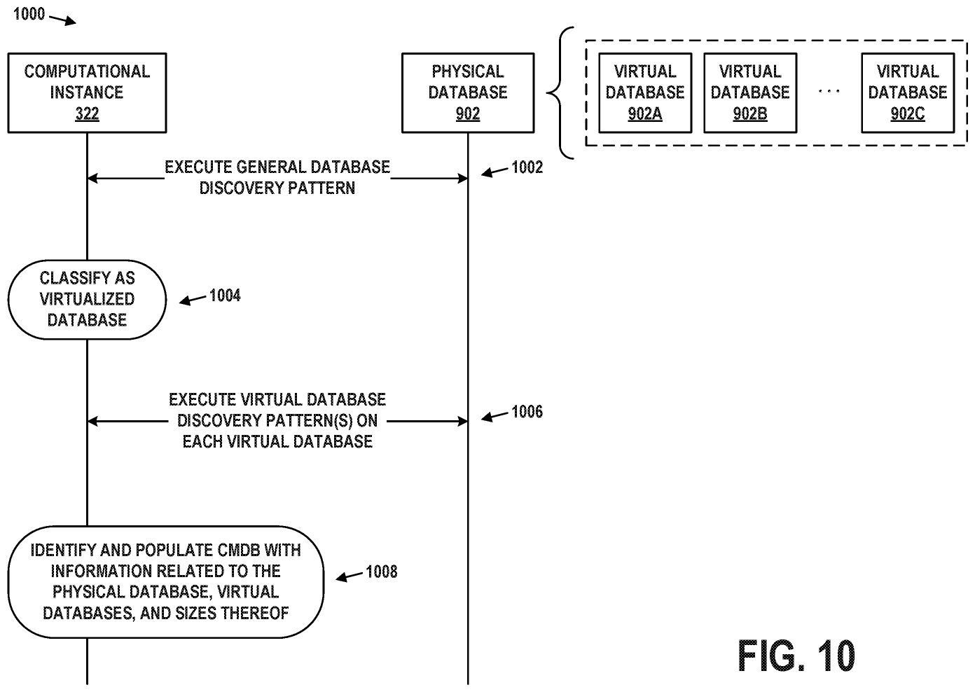

A virtualized database architecture can be discovered by querying one or more of these tables. An example of such a discovery procedure is illustrated in FIG. 10. As described above, discovery may be carried out by a computational instance providing instructions to a proxy server on the managed network, and the proxy server executing probes of the physical database.

In some embodiments, these probes may involve the proxy server remotely logging on to the physical database (e.g., via SSH), running one or more commands by way of a command shell, and gathering the output of these commands. From this output the computational instance and/or the proxy server can identify configuration items and associated attributes, and save these to a CMDB. Other possibilities include probing various devices on the managed network by way of other protocols, such as SNMP or a REST or SOAP interface.

Regardless, message flow diagram 1000 of FIG. 10 depicts computational instance 322 carrying out a series of steps. While a proxy server may be involved in these steps, it is omitted from message flow diagram 1000 for sake of simplicity.

At step 1002, computational instance 322 executes a general database discovery pattern on physical database 902. This may involve computational instance 322 identifying that physical database 902 is running a variation of the UNIX® operating system (e.g., LINUX®) or a variation of the WINDOWS® operating system, and then remotely logging on to physical database 902 and executing commands. The output of one or more of these commands may indicate that physical database 902 is configured to execute database software and is also a container that hosts a number of virtual databases. The output may also provide information related to the size and usage of these databases in aggregate.

For example, computational instance 322 may query a general database configuration table (e.g., V$DATABASE) to determine whether physical database 902 is a container for virtual databases. If so, at step 1004, computational instance classifies physical database 902 as a virtualized database. Further, the SQL query below can be used to obtain the total database size, amount of this size that is used, and the amount of this size that is free, all in gigabytes.

col “Database Size” format a20
col “Free space” format a20
col “Used space” format a20
select round(sum(used.bytes) / 1024 / 1024 / 1024 ) || ‘ GB’ “Database
Size”,

| | |
|---|---|
| | round(sum(used.bytes) / 1024 / 1024 / 1024 ) − round(free.p / 1024 |
| | / 1024 / 1024) \|\| ‘ GB’ “Used space”, round(free.p / 1024 / 1024 / |
| | 1024) \|\| ‘ GB’ “Free space” |
| from | (select bytes from v$datafile union all select bytes from v$tempfile |
| | union all select bytes from v$log) used, (select sum(bytes) as p |
| | from dba_free_space) free group by free.p; |

At step 1006, computational instance 322 may further query a virtual database configuration table (e.g., V$PDBS) to determine the names, configurations, and sizes of each virtual database (e.g., virtual databases 902A, 902B, and 902C). Computational instance 322 also further query other table constructs (e.g., V$DATAFILE, V$DATAFILE, V$LOGS, and or DBA FREE SPACE) to determine further information about the physical database and its virtual databases.

To obtain the sizes of the virtual databases, the following JAVASCRIPT® code can be used on either UNIX® or WINDOWS® platforms.

Both the SQL query and the JAVASCRIPT® code above assume an ORACLE® database. But, other queries and/or units of code may be usable to obtain the same or similar information from ORACLE® or non-ORACLE® databases.

At step 1008, computational instance 322 may populate the CMDB with the information obtained in steps 1002, 1004, and 1006 (or information derived therefrom) related to physical database 902 and/or virtual databases 902A, 902B, and 902C). This information may be stored in database tables.

var ciType = CTX.getAttribute(‘pattern_ cit_id’);
var credList = CTX.getApplicativeCredentials(ciType).iterator( );
var str =“”;
var os = ${computer_system.osFamily};
var cmd = “”;
while(credList.hasNext( ))
{

creds = credList.next( );
var user = creds.getUserName( );
var password =creds.getPassword( );
if (os == “UNIX”){

cmd = “export TNS_ADMIN=” + ${ora_home_exe} + “/network/admin; export

ORACLE_HOME=” + ${ora_home_exe} + “; \”“ + ${ora_home_exe} + ”/bin/sqlplus\“
-s ” + user + “/‘” + password + “’@” + ${computer_system.primaryHostname} +
“:” + ${defined_services[1].port} + “/” + ${pdb_size[ ].sid} + “ @” +
${sqlQuery} + “| grep GB”;

try {

str = CTX.getCommandManager( ).shellCommand(cmd, false, null, null,

CTX);

rtrn = str; } catch(e){ }

}
if (os == “WINDOWS”) {

cmd = “\”“ + ${ora_home_exe} + ”\\bin\\sqlplus\“ -s ” + user + “/” +

password+ “@” + ${computer_ system.primaryHostname} + “:” +
${defined_services[1].port} + “/” + ${pdb_size[ ].sid} + “ @” + ${sqlQuery} +
“| findstr GB”;

try {

str = CTX.getCommandManager( ).shellCommand(cmd, false, null, null,

CTX);

rtrn = str; } catch(e){ }

}

}

B. Schema

Information regarding the physical database may be stored in a specific database table (e.g., named cmdb_ci_db_instance for example). This information may include the physical database's name, configuration, size, and so on. The extent of this information may be quite large, so the schema of this table is omitted for purposes of simplicity.

TABLE 4
cmdb_ci_db_virtual_instance

| | |
|---|---|
| sid | Name of this virtual database. |
| name | The name of this configuration item in the CMDB; |
| | a combination of the sid and hostname of the |
| | virtual database |
| version | Version of this virtual database, taken from its |
| | parent physical database |
| edition | Edition of this virtual database, taken from its |
| | parent physical database |
| install_directory | The file system directory in which this virtual |
| | database is installed; taken from its parent |
| | physical database |
| home | The home file system directory of this virtual |
| | database; taken from its parent physical database |
| cdb_name | The sid name of the parent physical database that |
| | contains this virtual database |

Table 4 represents an example database table that can store information related to virtual databases. It is named cmdb_ci_db_virtual_instance, though other names may be used. For each virtual database, cmdb_ci_db_virtual_instance contains its name, version, edition, installation directory, home directory, and the name of the physical database that contains the virtual database. This information may be stored in the CMDB at step 1008.

TABLE 5
cmdb_ci_db_instance_size

| | |
|---|---|
| sid | Name of this database. |
| name | The name of this configuration item in the CMDB; |
| | a combination of the sid and hostname of the database |
| db_size | Total size of storage allocated to this database (e.g., in |
| | gigabytes) |
| used_size | Amount of the total size used by this database (e.g., in |
| | gigabytes) |
| free_size | Amount of the total size that is free in this database |
| | (e.g., in gigabytes) |

Table 5 represents an example database table that contains information related to the size of either a physical database or a virtual database. It is named cmdb_ci_db_instance size, though other names may be used. For each database, cmdb_ci_db_instance size contains its name, total size, amount of the total size used, and amount of the total size free. This information may also be stored in the CMDB at step 1008.

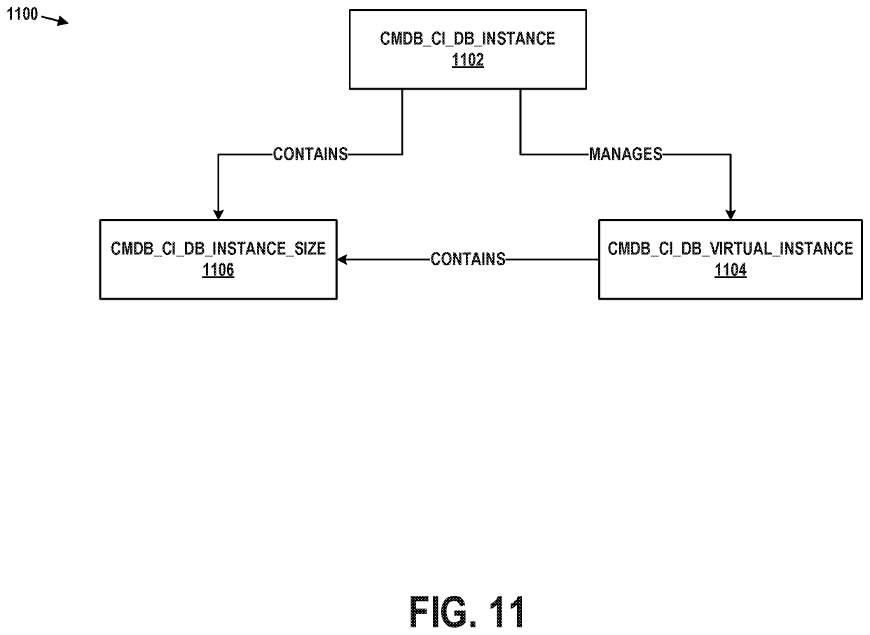

FIG. 11 defines partial schema 1100 with which a CMDB can store information about and relationships between configuration items discovered with the procedures of FIG. 10. In particular, relationships between the CMDB tables discussed above are defined. Partial schema 1100 could be part of a larger schema that relates these tables with other CMDB tables.

Table cmdb_ci_db_instance 1102 defines physical databases, each of which may include virtual databases. Table cmdb_ci_db_virtual_instance 1104 defines virtual databases. Thus, entries in table cmdb_ci_db_instance 1102 manage entries in table cmdb_ci_db_virtual_instance 1104. Table cmdb_ci_db_instance size 1106 defines the size and storage utilization information for a database (physical or virtual). Thus, entries from both tables cmdb_ci_db_instance 1102 and cmdb_ci_db_virtual_instance 1104 contain (e.g., have references to) entries in table cmdb_ci_db_instance size 1106. Notably, entries in table cmdb_ci_db_instance size 1106 may refer to a physical or virtual database by way of the sid or name columns, while entries in table cmdb_ci_db_virtual_instance 1104 may refer to a physical database by way of the cdb_name column.

C. Example Operations

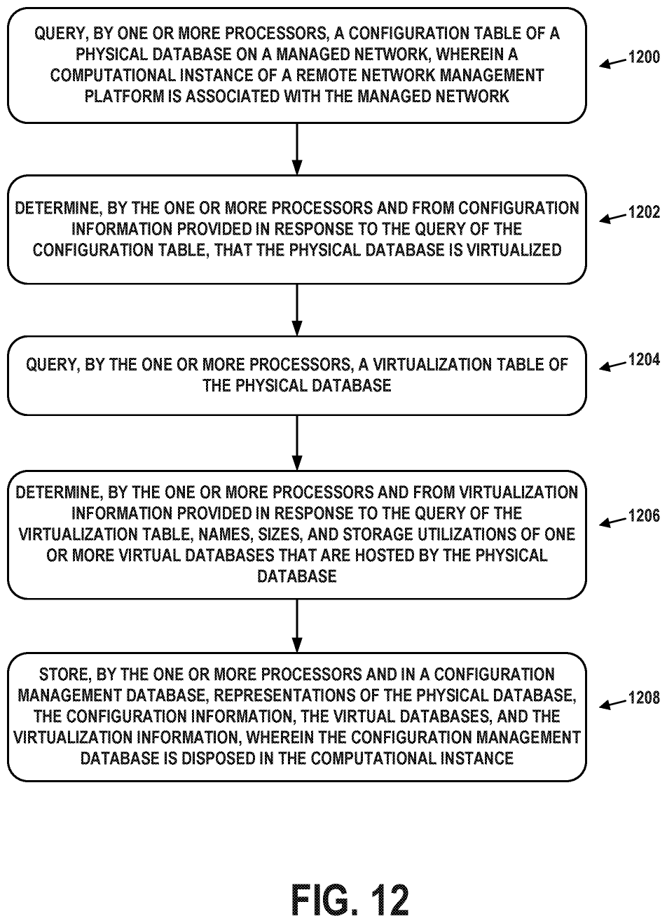

FIG. 12 is a flow chart illustrating an example embodiment. The process illustrated by FIG. 12 may be carried out by a computing device, such as computing device 100, and/or a cluster of computing devices, such as server cluster 200, computational instance 322, or a combination of computational instance 322 and proxy server 312. However, the process can be carried out by other types of devices or device subsystems.

The embodiments of FIG. 12 may be simplified by the removal of any one or more of the features shown therein. Further, these embodiments may be combined with features, aspects, and/or implementations of any of the previous figures or otherwise described herein.

Block 1200 may involve querying, by one or more processors, a configuration table of a physical database on a managed network, wherein a computational instance of a remote network management platform is associated with the managed network.

Block 1202 may involve determining, by the one or more processors and from configuration information provided in response to the query of the configuration table, that the physical database is virtualized.

Block 1204 may involve querying, by the one or more processors, a virtualization table of the physical database.

Block 1206 may involve determining, by the one or more processors and from virtualization information provided in response to the query of the virtualization table, names, sizes, and storage utilizations of one or more virtual databases that are hosted by the physical database.

Block 1208 may involve storing, by the one or more processors and in a configuration management database, representations of the physical database, the configuration information, the virtual databases, and the virtualization information, wherein the configuration management database is disposed in the computational instance.

In some embodiments, a proxy server device is disposed within the managed network and controlled by the computational instance, and the one or more processors are disposed in the proxy server device and the computational instance. In other embodiments, the one or more processors are disposed in the computational instance.

In some embodiments, the representations of the physical database and at least some of the configuration information are stored in a first table of the configuration management database, and the representations of the virtual databases and at least part of the virtualization information are stored in a second table of the configuration management database.

In some embodiments, the configuration information includes a size and storage utilization of the physical database, and representations of sizes and storage utilizations of the physical database and the virtual databases are stored in a third table of the configuration management database.

In some embodiments, the physical database and the virtual databases are respectively associated with unique identifiers, and an entry in the third table includes a parameter that specifies the unique identifier associated with the physical database or one of the virtual databases to which the entry applies.

In some embodiments, the physical database has a name, and all entries in the second table include parameters that specify the name.

In some embodiments, the sizes and storage utilizations of the virtual databases are also based on further information provided in response to a query of a further table of the physical database.

### VIII. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, or compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
a computational instance of a remote network management platform that is associated with a managed network, wherein a database is disposed within the computational instance;
one or more processors configured to:
execute discovery of a supervisor device disposed in the managed network, wherein the discovery of the supervisor device involves: (i) executing a first general discovery pattern, (ii) based on output of commands invoked on the supervisor device by the first general discovery pattern, executing a supervisor device discovery pattern on the supervisor device, (iii) based on results of the executing the supervisor device discovery pattern, identifying a first set of configuration and operational parameters of the supervisor device, one or more physical devices managed by the supervisor device, and virtual devices hosted by each of the one or more physical devices, and (iv) storing, in the database, the first set of configuration and operational parameters; and
execute discovery of a particular virtual device of the virtual devices, wherein executing discovery of the particular virtual device involves: (i) executing a second general discovery pattern, (ii) based on output of commands invoked on the particular virtual device by the second general discovery pattern, identifying a second set of configuration and operational parameters of the particular virtual device, and (iii) storing, in the database, the second set of configuration and operational parameters, wherein a unique identifier of the particular virtual device is used to relate information from the first set and the second set in the database.

2. The system of claim 1, further comprising:
a proxy server device, disposed within the managed network and controlled by the computational instance, wherein the one or more processors are disposed in the proxy server device and the computational instance.

3. The system of claim 1, wherein the one or more processors are disposed in the computational instance.

4. The system of claim 1, wherein the discovery of the supervisor device occurs before the discovery of the particular virtual device.

5. The system of claim 1, wherein the discovery of the particular virtual device occurs before the discovery of the supervisor device.

6. The system of claim 1, wherein the commands invoked on the supervisor device and the commands invoked on the particular virtual device are shell commands invoked by remotely accessing the supervisor device and the particular virtual device, respectively.

7. The system of claim 1, wherein the first set of configuration and operational parameters include data indicating that the one or more physical devices are managed by the supervisor device and that each of the one or more physical devices hosts one or more of the virtual devices, and wherein parts of the first set of configuration and operational parameters that relate to discovered supervisor devices, discovered physical devices, and discovered virtual devices are respectively stored in different tables of the database.

8. The system of claim 1, wherein some of the virtual devices are virtual input/output (VIO) servers that are dedicated to managing physical interface or peripheral components of their respective physical devices, and wherein at least some non-VIO virtual devices use one of the VIO servers to access the physical interface or peripheral components.

9. The system of claim 1, wherein the database maintains a high watermark of resource utilization for the particular virtual device, wherein the second set of configuration and operational parameters contains an updated measurement of resource utilization for the particular virtual device, and wherein executing discovery of the particular virtual device involves, when the updated measurement exceeds the high watermark, replacing the high watermark with the updated measurement.

10. The system of claim 1, wherein the one or more processors are further configured to:
execute discovery of a second particular virtual device of the virtual devices, wherein executing discovery of the second particular virtual device involves: (i) executing the second general discovery pattern, (ii) based on output of commands invoked on the second particular virtual device by the second general discovery pattern, identifying a third set of configuration and operational parameters of the second particular virtual device, and (iii) storing, in the database, the third set of configuration and operational parameters, wherein a second unique identifier of the second particular virtual device is used to relate information from the first set and the third set in the database.

11. A computer-implemented method comprising:
executing, by one or more processors, discovery of a supervisor device disposed in a managed network, wherein the discovery of the supervisor device involves: (i) executing a first general discovery pattern, (ii) based on output of commands invoked on the supervisor device by the first general discovery pattern, executing a supervisor device discovery pattern on the supervisor device, (iii) based on results of the executing the supervisor device discovery pattern, identifying a first set of configuration and operational parameters of the supervisor device, one or more physical devices managed by the supervisor device, and virtual devices hosted by each of the one or more physical devices, and (iv) storing, in a database, the first set of configuration and operational parameters; and
executing, by the one or more processors, discovery of a particular virtual device of the virtual devices, wherein executing discovery of the particular virtual device involves: (i) executing a second general discovery pattern, (ii) based on output of commands invoked on the particular virtual device by the second general discovery pattern, identifying a second set of configuration and operational parameters of the particular virtual device, and (iii) storing, in the database, the second set of configuration and operational parameters, wherein a unique identifier of the particular virtual device is used to relate information from the first set and the second set in the database.

12. The computer-implemented method of claim 11, wherein the first set of configuration and operational parameters include data that indicating that the one or more physical devices are managed by the supervisor device and that each of the one or more physical devices hosts one or more of the virtual devices, and wherein parts of the first set of configuration and operational parameters that related to discovered supervisor devices, discovered physical devices, and discovered virtual devices are respectively stored in different tables of the database.

13. The computer-implemented method of claim 11, wherein some of the virtual devices are virtual input/output (VIO) servers that are dedicated to managing physical interface or peripheral components of their respective physical devices, and wherein at least some non-VIO virtual devices use one of the VIO servers to access the physical interface or peripheral components.

14. The computer-implemented method of claim 11, wherein the database maintains a high watermark of resource utilization for the particular virtual device, wherein the second set of configuration and operational parameters contains an updated measurement of resource utilization for the particular virtual device, and wherein executing discovery of the particular virtual device involves, when the updated measurement exceeds the high watermark, replacing the high watermark with the updated measurement.

15. A system comprising:
a computational instance of a remote network management platform that is associated with a managed network, wherein a configuration management database is disposed within the computational instance; and
one or more processors configured to:
query a configuration table of a physical database on the managed network;
determine, from configuration information provided in response to the query of the configuration table, that the physical database is virtualized;
query a virtualization table of the physical database;
determine, from virtualization information provided in response to the query of the virtualization table, names, sizes, and storage utilizations of one or more virtual databases that are hosted by the physical database; and
store, in the configuration management database, representations of the physical database, the configuration information, the virtual databases, and the virtualization information.

16. The system of claim 15, further comprising:
a proxy server device, disposed within the managed network and controlled by the computational instance, wherein the one or more processors are disposed in the proxy server device and the computational instance.

17. The system of claim 15, wherein the one or more processors are disposed in the computational instance.

18. The system of claim 15, wherein the representations of the physical database and at least some of the configuration information are stored in a first table of the configuration management database, and wherein the representations of the virtual databases and at least part of the virtualization information are stored in a second table of the configuration management database.

19. The system of claim 18, wherein the configuration information includes a size and storage utilization of the physical database, and wherein representations of sizes and storage utilizations of the physical database and the virtual databases are stored in a third table of the configuration management database.

20. The system of claim 19, wherein the physical database and the virtual databases are respectively associated with unique identifiers, and wherein an entry in the third table includes a parameter that specifies the unique identifier associated with the physical database or one of the virtual databases to which the entry applies.
